(19) United States
(12) Patent Application Publication
(10) Pub. No.: US 2015/0200579 A1
(43) Pub. Date: Jul. 16, 2015

(54) MOTOR ROTOR AND METHOD FOR MANUFACTURING THE SAME

(71) Applicant: SAMSUNG ELECTRO-MECHANICS CO., LTD., Gyeonggi-Do (KR)

(72) Inventors: Sang Ho SEO, Gyeonggi-Do (KR); Yong Wan CHO, Gyeonggi-Do (KR); Hyun Taek AHN, Gyeonggi-Do (KR)

(73) Assignee: SAMSUNG ELECTRO-MECHANICS CO., LTD., Gyeonggi-Do (KR)

(21) Appl. No.: 14/271,050

(22) Filed: May 6, 2014

(30) Foreign Application Priority Data
Jan. 10, 2014 (KR) 10-2014-0003524

(51) Int. Cl. H02K 7/04; H02K 15/02; H02K 15/16

(52) U.S. Cl. CPC H02K 7/04; H02K 15/165; H02K 15/02

(57) ABSTRACT

Embodiments of the invention provide a motor rotor including a shaft, a rotor core having the shaft coupled thereto, and a balancing part formed integrally with the rotor core and the shaft, wherein the balancing part includes a balancing protrusion protruding therefrom.

### CROSS REFERENCE TO RELATED APPLICATION

This application claims the benefit of and priority under 35 U.S.C. §119 to Korean Patent Application No. KR 10-2014-0003524, entitled “Motor Rotor and Method for Manufacturing the Same,” filed on Jan. 10, 2014, which is hereby incorporated by reference in its entirety into this application.

### BACKGROUND

1. Field of the Invention

The present invention to a motor rotor and a method for manufacturing the same.

2. Description of the Related Art

Generally, a motor for a clearer has a structure in which a motor and a fan assembly are coupled to each other, and each component of the motor progresses according to a flow of an assembling process thereof.

A rotor assembly, which is a driving component of the motor converting electric energy into mechanical energy to drive a fan of the cleaner among the components of the motor, is configured to a rotor core, a shaft, and a balancing part.

Here, in a general rotor assembly according to the convention art, for example, in Korean Patent No. 0808205, the shaft and the balancing part are manufactured by a mold, respectively, and are machined, and are then coupled to each other.

However, an error occurs at the time of manufacturing the shaft and the balancing part by the mold. In addition, even though the shaft and the balancing part are machined and are then assembled to each other, it is difficult to completely prevent occurrence of a coupling error, and problems such noise, weakness of coupling force, and damage to a coupled portion occur due to the coupling error. In addition, there is a problem that dispersion occurs at the time of performing the machining using the mold.

Further, a balancing work is not easy, such that a process time is long and it is difficult to accomplish automation.

### SUMMARY

Accordingly, embodiments of the invention provide a motor rotor in which a shaft, a rotor core, and a balancing part are formed integrally with one another.

Further, embodiments of the invention have been made in an effort to provide a motor rotor capable of being easily balanced.

According to an embodiment of the invention, there is provided a motor rotor including a shaft, a rotor core having the shaft coupled thereto, and a balancing part formed integrally with the rotor core and the shaft, wherein the balancing part includes a balancing protrusion protruding therefrom.

According to an embodiment, the balancing protrusion is eccentrically positioned at the balancing part, respectively.

According to an embodiment, the number of the balancing protrusion is plural, and the balancing protrusions are eccentrically positioned at one side of an upper end and the other side of a lower end of the balancing part, respectively.

According to an embodiment, the number of the balancing protrusion is plural, and the balancing protrusions are eccentrically positioned at the balancing part, respectively, and are positioned at a diagonal direction, respectively.

According to an embodiment, the balancing protrusion has 5 to 15 weight % based on an entire weight % of the balancing part.

According to an embodiment, the balancing protrusion has 10 weight % based on the entire weight % of the balancing part.

According to an embodiment, the balancing part is formed by injection-molding.

According to an embodiment, a material of the injection molding is a high strength plastic.

According to an embodiment, the balancing part is formed at both ends of the rotor core and over an outer peripheral surface of the shaft.

According to another embodiment of the invention, there is provided a method for manufacturing a motor rotor, including a shaft coupling step of coupling a shaft to a rotor core, and a balancing part molding step of injection-molding a balancing part after the shaft and the rotor core coupled to each other is positioned in a molding frame, wherein in the balancing part molding step, the balancing part is injection-molded to have a balancing protrusion protruding therefrom.

According to an embodiment, in the balancing part molding step, the balancing part is injection-molded so that the balancing protrusion is eccentrically positioned at the balancing part, respectively.

According to an embodiment, in the balancing part molding step, the balancing part is injection-molded so that the number of the balancing protrusion is plural.

According to an embodiment, in the balancing part molding step, the balancing part is injection-molded so that the plurality of balancing protrusions are eccentrically positioned at one side of an upper end and the other side of a lower end of the balancing part, respectively.

According to an embodiment, in the balancing part molding step, the balancing part is injection-molded so that the plurality of balancing protrusions are positioned at a diagonal direction, respectively.

According to an embodiment, in the balancing part molding step, the balancing part is injection-molded so that the balancing protrusion has 5 to 15 weight % based on an entire weight % of the balancing part.

According to an embodiment, in the balancing part molding step, the balancing part is injection-molded so that the balancing protrusion has 10 weight % based on the entire weight % of the balancing part.

According to an embodiment, a material of the injection molding is a high strength plastic.

According to an embodiment, in the balancing part molding step, the balancing part is injection-molded so that it is formed integrally with the shaft and the rotor core.

According to an embodiment, the method for manufacturing a motor rotor further includes, after the balancing part molding step, a balancing step of balancing the motor rotor, while milling the balancing protrusions.

According to an embodiment, in the shaft coupling step, the shaft is press-fitted into the rotor core to thereby be coupled thereto.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a perspective view showing a motor rotor according to an embodiment of the invention.

FIG. 2 is an exploded perspective view showing the motor rotor according to an embodiment of the invention.

FIG. 3 is a perspective view showing a rotor core and a balancing part in the motor rotor according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

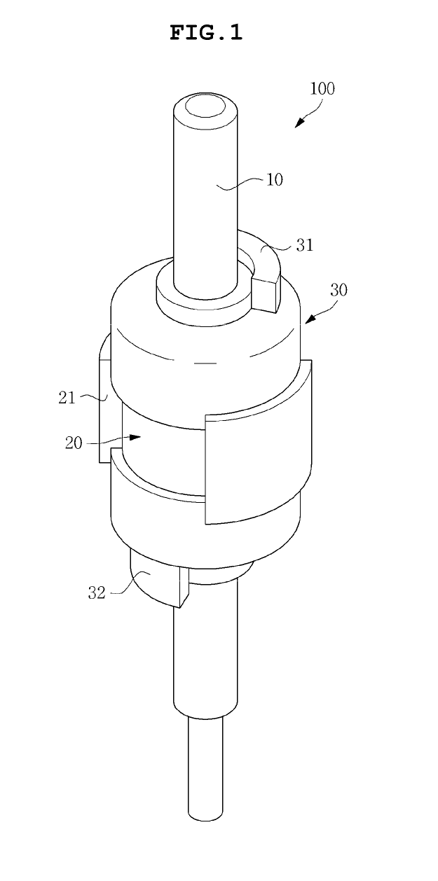

FIG. 1 is a perspective view showing a motor rotor according to an embodiment of the invention.

Referring to FIG. 1, the motor rotor 100 according to an embodiment of the invention is configured to include a shaft 10, a rotor core 20, and a balancing part 30.

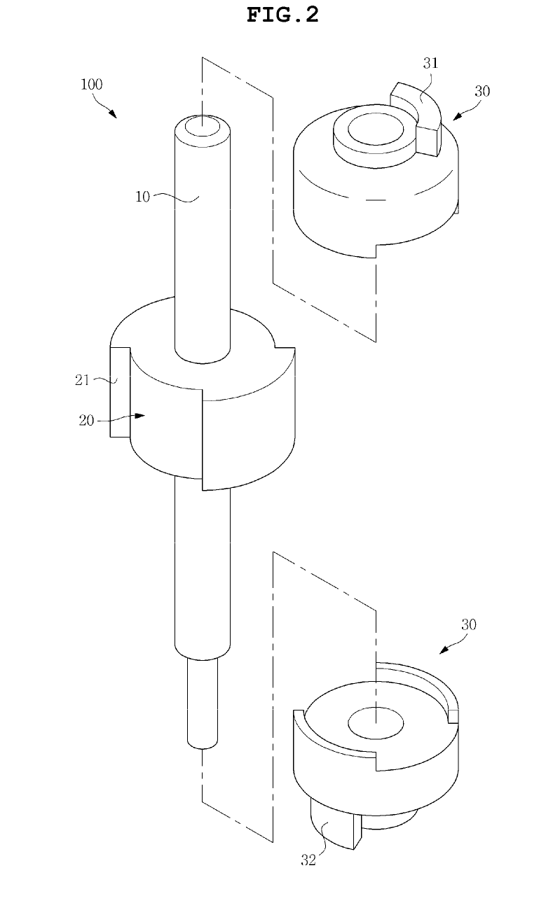

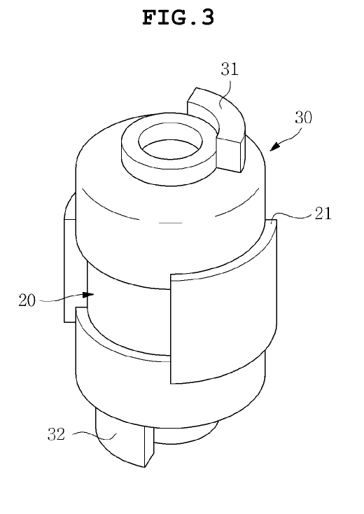

FIG. 2 is an exploded perspective view showing the motor rotor according to an embodiment of the invention, and FIG. 3 is a perspective view showing a rotor core 20 and a balancing part 30 in the motor rotor according to an embodiment of the invention.

Referring to FIGS. 1 to 3, the shaft 10 provides a supporting body and a rotating body on which components of the motor rotor 100 are mounted and has both sides mounted in a housing (not shown) of a motor through bearings (not shown).

According to an embodiment, the rotor core 20 is provided with a plurality of salient poles 21 protruding from a side thereof. Here, the rotor core 20 has a permanent magnet (not shown) accommodated therein or configured of only an iron core without the permanent magnet.

In addition, according to an embodiment of the invention, the rotor core 20 generates a magnetic force together with a stator (not shown) disposed at a position corresponding thereto at an outer side thereof to rotate the motor rotor 100.

According to an embodiment, the balancing part 30 is formed at upper and lower ends of the rotor core 20 and over an outer peripheral surface of the shaft 10 to fix the rotor core 20 to prevent the rotor core 20 from being separated upwardly or downwardly. In addition, the balancing part 30 balances the motor rotor 100.

In addition, according to an embodiment of the invention, the balancing part 30 includes balancing protrusions 31 and 32 eccentrically formed to be unbalanced. Therefore, the motor rotor 100 is entirely balanced easily by a process of balancing the balancing protrusions 31 and 32, while milling the balancing protrusions 31 and 32.

According to an embodiment, the number of balancing protrusions 31 and 32 is plural, and the balancing protrusions include first and second balancing protrusions 31 and 32.

In addition, according to an embodiment of the invention, the first balancing protrusion 31 is eccentrically positioned at one side of an upper end of the balancing part 30, and the second balancing protrusion 32 is eccentrically positioned at the other side of a lower end of the balancing part 30.

Further, according to an embodiment of the invention, the first and second balancing protrusions 31 and 32 are positioned in a diagonal direction, respectively.

Further, according to an embodiment of the invention, the balancing protrusions 31 and 32 have 5 to 15 weight % based on an entire weight % of the balancing part 30. In more detail, the balancing protrusions 31 and 32 have 10 weight % based on the entire weight % of the balancing part 30.

According to an embodiment, when the number of balancing protrusions 31 and 32 is plural, an entire weight % of the plurality of balancing protrusions 31 and 32 is 5 to 15 weight % based on the entire weight % of the balancing part 30. In this case, as an example, the entire weight % of the plurality of balancing protrusions 31 and 32 is 10 weight % based on the entire weight % of the balancing part 30.

According to an embodiment, the balancing part 30 is injection-molded after the shaft 10 and the rotor core 20 are positioned in a molding frame before injection-molding, such that the shaft 10, the rotor core 20, and the balancing part 30 are formed integrally with one another. Here, the shaft 10 is press-fitted into a coupling hole (not shown) of the rotor core 20 to thereby be coupled thereto. Here, according to an embodiment, a material of the injection-molding is a high strength plastic.

According to an embodiment, a method for manufacturing a motor rotor according to an embodiment of the invention will be described in detail with reference to FIGS. 1 to 3.

According to an embodiment, the method for manufacturing a motor rotor according to an embodiment of the invention includes a shaft coupling step and a balancing part molding step.

According to an embodiment, in the shaft coupling step, the shaft 10 is coupled to the rotor core 20. Here, the shaft 10 is press-fitted into a coupling hole (not shown) formed at a central portion of the rotor core 20 to thereby be coupled thereto.

According to an embodiment, in the balancing part molding step, the balancing part 30 is injection-molded after the shaft 10 and the rotor core 20 coupled to each other is positioned in the molding frame.

In addition, according to an embodiment, the balancing part 30 is injection-molded to be formed at the upper and lower ends of the rotor core 20 and over the outer peripheral surface of the shaft 10 to fix the rotor core 20 to prevent the rotor core 20 from being separated upwardly or downwardly.

Further, in the balancing part molding step, the balancing part 30 is injection-molded to have the balancing protrusions 31 and 32 protruding therefrom.

In addition, according to an embodiment, the balancing part 30 is injection-molded so that the balancing protrusions 31 and 32 are eccentrically positioned. Here, the balancing protrusions 31 and 32 are eccentrically formed to be unbalanced with respect to the shaft 10 positioned at a central portion of the balancing part 30.

In addition, according to an embodiment, the balancing part 30 is injection-molded so that the number of balancing protrusions 31 and 32 is plural, and the balancing protrusions includes the first and second balancing protrusions 31 and 32.

According to an embodiment, the first balancing protrusion 31 is eccentrically positioned at one side of the upper end of the balancing part 30, and the second balancing protrusion 32 is eccentrically positioned at the other side of the lower end of the balancing part 30.

Further, according to an embodiment, the first and second balancing protrusions 31 and 32 are positioned in a diagonal direction, respectively.

Further, according to an embodiment, the balancing protrusions 31 and 32 have 5 to 15 weight % based on an entire weight % of the balancing part 30. In more detail, the balancing protrusions 31 and 32 have 10 weight % based on the entire weight % of the balancing part 30.

When the number of balancing protrusions 31 and 32 is plural, an entire weight % of the plurality of balancing protrusions 31 and 32 is 5 to 15 weight % based on the entire weight % of the balancing part 30. In this case, as an example, the entire weight % of the plurality of balancing protrusions 31 and 32 is 10 weight % based on the entire weight % of the balancing part 30.

In addition, in the balancing part molding step, the balancing part 30 is injection-molded after the shaft 10 and the rotor core 20 are positioned in the molding frame before the injection-molding, such that the shaft 10, the rotor core 20, and the balancing part 30 are formed integrally with one another. Here, according to an embodiment, a material of the injection-molding is a high strength plastic.

The method for manufacturing a motor rotor according to an embodiment of the invention further includes a balancing step.

In the balancing step, the motor rotor 100 is balanced, while milling the balancing protrusions 31 and 32 after the balancing part molding step. Therefore, the motor rotor 100 is entirely balanced easily.

According to embodiments of the invention, the shaft, the rotor core, and the balancing part are injection-molded integrally with one another, thereby making it possible to decrease a weight of the motor and decrease dispersion occurring at the time of manufacturing rotor components using a mold and machining the rotor components.

Further, according to various embodiments, occurrence of a coupling error at a coupled portion among the shaft, the rotor core, and the balancing part is prevented. Therefore, occurrence of noise at the coupled portion is prevented.

According to various embodiments of the invention, the rotor is easily balanced, thereby making it possible to simplify a process and easily accomplish automation.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A motor rotor, comprising:
a shaft;
a rotor core having the shaft coupled thereto; and
a balancing part formed integrally with the rotor core and the shaft,
wherein the balancing part comprises a balancing protrusion protruding therefrom.

2. The motor rotor as set forth in claim 1, wherein the balancing protrusion is eccentrically positioned at the balancing part.

3. The motor rotor as set forth in claim 1, wherein the number of the balancing protrusion is plural, and
wherein the balancing protrusions are eccentrically positioned at one side of an upper end and the other side of a lower end of the balancing part, respectively.

4. The motor rotor as set forth in claim 1, wherein the number of the balancing protrusion is plural, and the balancing protrusions are eccentrically positioned at the balancing part, respectively, and are positioned at a diagonal direction, respectively.

5. The motor rotor as set forth in claim 1, wherein the balancing protrusion has 5 to 15 weight % based on an entire weight % of the balancing part.

6. The motor rotor as set forth in claim 5, wherein the balancing protrusion has 10 weight % based on the entire weight % of the balancing part.

7. The motor rotor as set forth in claim 1, wherein the balancing part is formed by injection-molding.

8. The motor rotor as set forth in claim 7, wherein a material of the injection molding is a high strength plastic.

9. The motor rotor as set forth in claim 1, wherein the balancing part is formed at both ends of the rotor core and over an outer peripheral surface of the shaft.

10. A method for manufacturing a motor rotor, comprising:
a shaft coupling step of coupling a shaft to a rotor core; and
a balancing part molding step of injection-molding a balancing part after the shaft and the rotor core coupled to each other is positioned in a molding frame,
wherein, in the balancing part molding step, the balancing part is injection-molded so as to have a balancing protrusion protruding therefrom.

11. The method for manufacturing a motor rotor as set forth in claim 10, wherein, in the balancing part molding step, the balancing part is injection-molded so that the balancing protrusion is eccentrically positioned at the balancing part, respectively.

12. The method for manufacturing a motor rotor as set forth in claim 10, wherein, in the balancing part molding step, the balancing part is injection-molded so that the number of the balancing protrusion is plural.

13. The method for manufacturing a motor rotor as set forth in claim 12, wherein, in the balancing part molding step, the balancing part is injection-molded so that the plurality of balancing protrusions are eccentrically positioned at one side of an upper end and the other side of a lower end of the balancing part, respectively.

14. The method for manufacturing a motor rotor as set forth in claim 12, wherein, in the balancing part molding step, the balancing part is injection-molded so that the plurality of balancing protrusions are positioned at a diagonal direction, respectively.

15. The method for manufacturing a motor rotor as set forth in claim 10, wherein, in the balancing part molding step, the balancing part is injection-molded so that the balancing protrusion has 5 to 15 weight % based on an entire weight % of the balancing part.

16. The method for manufacturing a motor rotor as set forth in claim 15, wherein, in the balancing part molding step, the balancing part is injection-molded so that the balancing protrusion has 10 weight % based on the entire weight % of the balancing part.

17. The method for manufacturing a motor rotor as set forth in claim 10, wherein a material of the injection molding is a high strength plastic.

18. The method for manufacturing a motor rotor as set forth in claim 10, wherein, in the balancing part molding step, the balancing part is injection-molded so that it is formed integrally with the shaft and the rotor core.

19. The method for manufacturing a motor rotor as set forth in claim 10, further comprising:
after the balancing part molding step, a balancing step of balancing the motor rotor, while milling the balancing protrusions.

20. The method for manufacturing a motor rotor as set forth in claim 10, wherein in the shaft coupling step, the shaft is press-fitted into the rotor core to thereby be coupled thereto.
